(19) United States
(12) Patent Application Publication
(10) Pub. No.: US 2016/0001351 A1
(43) Pub. Date: Jan. 7, 2016

(54) HOLLOW DRIVE SHAFT WITH FLANGE AND METHOD FOR THE PRODUCTION THEREOF

(71) Applicants: Friedhelm GUNTHER, Dortmund (DE); Ralf DIRSCHERL, Thüngen (DE); Marco SCHMIDT, Thüngen (DE)

(72) Inventors: Friedhelm GUNTHER, Dortmund (DE); Ralf DIRSCHERL, Thüngen (DE); Marco SCHMIDT, Thüngen (DE)

(21) Appl. No.: 14/379,792

(22) PCT Filed: Feb. 27, 2012
(86) PCT No.: PCT/EP2012/053286

§ 371 Date: Sep. 11, 2015

(51) Int. Cl. B21K 1/06; B21D 53/84; B21C 1/24; B21D 19/04; F16C 3/02; B21C 1/18

(52) U.S. Cl. CPC B21K 1/063; F16C 3/02; B21C 1/18; B21C 1/24; B21D 19/046; B21D 53/84

(57) ABSTRACT

A method for producing a tubular, hollow drive shaft, in particular a cardan shaft, from a pre-tube, in particular a longitudinally welded, normalized steel tube, which is extended by having the wall thickness thereof reduced at least sectionally by way of single or multiple ironing or another cold forming operation and/or by having the inner diameter and/or outer diameter thereof changed, wherein at least one pre-tube end or shaft end is configured into a flange that is integrated in one piece by to way of cold forming.

### BACKGROUND OF THE INVENTION

The invention relates to a method for producing a tubular, hollow drive shaft, in particular a cardan shaft, from a pre-tube. This can be a longitudinally welded, normalized steel tube, for example. Over the course of the production process, the pre-tube is extended by having the wall thickness thereof reduced at least sectionally by way of single or multiple ironing or another cold forming operation and/or by having the inner diameter and/or outer diameter thereof changed. The invention further relates to a hollow drive shaft, in particular a cardan shaft, which is hardened by way of ironing and/or another cold forming operation and, in the process, is provided with differing wall thicknesses and/or with differing inner diameters and/or outer diameters across the longitudinal extension thereof, in particular produced according to the afore-mentioned method.

High-strength, cold-formed cardan shaft parts for drive trains, produced according to the method described above, for example, are known (DE 10 2007 045 719 A1). According to this document, propeller shafts or cardan shafts are used to transmit torque from an internal combustion engine of a motor vehicle, for example, to the drive axle thereof. The transmittable torque should be as high as possible, but on the other hand, the cardan shaft should have as low a dead weight as possible for the purpose of minimized energy consumption. Typically, steel of the grade E355+N (see European standard EN 10305-2 of November 2002, Tables 1 and 2, or EN 10305-3 of May 1, 2010) is the material used for the cardan shaft, but the use of other steel materials comprising alloys is also possible.

In addition to the production method disclosed in DE 10 2007 045 719 A1, the aforementioned steel tube is cold formed, which is to say ironed, wherein the pre-tube is given at least two different wall diameters and at least two different inner and outer diameters in the direction of the longitudinal axis. The cold forming operation results in increased strength for the deformed regions as compared to the pre-tube. Due to the volume constancy of the pre-tube, an extension results in the axial direction from the reduction of the wall thicknesses and of the diameters.

It is the object of the invention to expand the mechanical coupling options at the shaft end of a high-strength, cold-formed lightweight hollow drive shaft, in particular a cardan shaft. With respect to the solution to the problem, reference is made to the drive shaft production method described in claim 1 and to the hollow drive shaft described in claim 12. Optional embodiments of these inventions result from the dependent claims and the following description and the drawings.

### SUMMARY OF THE INVENTION

According to these, the formation of a terminal flange is incorporated in the cold forming process during production of the hollow drive shaft. This opens up the option of leaving the flange region with a thicker wall thickness as compared to other tube sections during cold forming, in particular during ironing, so that in particular the stability of the coupling of the flange, for example in the drive train of a motor vehicle, is increased. On the other hand, the cold forming operation allows the part of the pre-tube which is not associated with the flange, or adjoining the same, to be implemented in only a minimal wall thickness, which corresponds to the desired goal of the lightweight construction relative to the tube length. The strain hardening accompanying the cold forming operation additionally ensures the necessary high strength outside the flange region.

To ensure sufficient dimensional accuracy in the flange region as well, an optional embodiment of the invention provides for the cold forming operation of the pre-tube or shaft end section associated with the flange for obtaining a flange shape to also include at least a single ironing step of this end section on a mandrel. This is used for fine dimensioning of the wall thickness in the flange region. The advantage thus achieved is that a flange having a uniform wall thickness can be achieved more easily during subsequent bending or folding of the tube end to obtain the characteristic flange shape.

For the bending operation following the ironing of the flange region, an optional embodiment of the invention provides for this to be broken down into a pre-forming step and a subsequent flat forming step. In the pre-forming step, the wall at the end of the pre-tube is pre-formed using an at least sectionally conical, in particular circular cone-shaped bending punch. To this end, the wall at the tube end is given an angled position with respect to the tube axis by way of the outer jacket of the bending punch extending obliquely with respect to the tube axis. For the flat forming step then, a different bending punch having an orthogonal contour is used, so as to bend the previously obliquely positioned wall into a perpendicular position with respect to the tube axis. The combination of these two deforming steps as part of the cold forming operation opens up the option of being able to dispense with rotatory movement components in the tools that are the bending punches in conjunction with the pressure pad die. This simplifies the composition and design of the necessary bending/forming tools.

Two-stage flange formation with oblique positioning and subsequent flat positioning of the tube end is known from DE 199 53 525 C2 “Method for producing a metallic formed tubular part.” However, the end to be formed is heated to a forging temperature prior to forming. Cold forming, in conjunction with strain hardening, consequently cannot take place. The dimensional accuracy is reduced as compared to the cold forming operation used according to the invention due to heat shrinkage occurring as a result of hot forming. DE 199 53 525 C2 consequently discloses a metallic tube having only a uniform wall thickness. The use as a camshaft is disclosed as a specific application.

The flat forming step advantageously includes pressing the flange end face flat up to the yield limit, and more particularly embossing the same, using the orthogonal bending punch. This forms a clear end face shape for the flange on the end face or connection side.

It is useful for increasing the strength of the flange formed at the tube end if a corrugation or a reinforcement rib is embossed into the flange according to another optional embodiment of the invention, using an appropriately adapted embossing tool. For the flat forming step, the orthogonal bending punch is advantageously already designed with an appropriate convex or concave, elongated curvature for embossing a corresponding elongate recess or elevation. In a further refinement of this embodiment of the invention, the corrugation, or recessed or raised reinforcement rib, is embossed into the 90° bending region where the tube region transitions into the flange region.

So as to ensure that no excessive stress occurs during the formation of the flange, according to an optional embodiment of the invention one or more wall parts, in particular curved sections of the tube wall, are severed, for example punched out, prior to forming the flange on the pre-tube or shaft end, in such a way that mutually spaced, axially parallel end face protrusions remain. For punching out, advantageously a stamping tool comprising a cutting punch and a cutting die can be used. The latter is provided with a cutting passage that is adapted to the wall parts to be punched out.

So as to achieve as lightweight a construction as possible relative to the desired tube length, as large a degree of forming as possible must be strived for during cold forming. The objective is to create the maximum possible wall thinning. One advantageous embodiment of the invention is useful for this, according to which the pre-tube is subjected to preliminary ironing in certain tube regions. More particularly, the tube sections that are ironed are those disposed in each case at a distance from the tube end region associated with the flange. During the preliminary ironing operation, the respective wall thickness is reduced and/or the respective inner diameter and/or outer diameter are narrowed and/or expanded.

As is known, material hardening occurs during cold forming, for example according to the afore-mentioned preliminary ironing. As a result, the ductility of the material is reduced. This is counteracted with an optional embodiment of the invention, according to which an intermediate annealing step (normalizing, in the case of steel from just under 800 to 950 degrees Celsius) preferably follows immediately the preliminary ironing operation. This allows the original structure to be restored in the tube material, the consequences of cold forming—this being strain hardening—to be substantially reversed, and the degree of deformation of the raw material to be increased again. During the further production stages, additional ironing steps can then be carried out so as to increase the differences in the wall thickness.

Additional ironing measures are advantageous, in particular after preliminary ironing and subsequent intermediate annealing, so as to refine the wall thicknesses, diameters and other geometric dimensions. Reductions in the outer diameter and/or inner diameter of the pre-tube and/or of the wall thicknesses thereof can take place between the tube ends, in the case of a tube end section not associated with the flange or one or more center sections, or also on the flange end section, prior to implementing the flange shape using specially configured forming tools.

The hollow drive shaft according to the invention, in particular the cardan tube, is characterized by the lightweight construction achieved by way of cold forming. The tube sections outside the flange region have a relatively thin wall thickness, and only the flange region formed thereon in one piece, or integrally formed thereon, has a thicker wall thickness as compared thereto so as to absorb higher torque. These differences in the wall thickness require multiple ironing operations with intermediate annealing, as described above. The shaft or tube sections outside the flange region advantageously transition into the flange region, or the tube or shaft section immediately adjoining thereon, via an outside diameter expansion that preferably extends obliquely in a ramp-like manner with respect to the tube axis.

An advantageous embodiment of the hollow drive shaft according to the invention is that the shaft or tube portion not associated with and/or not adjoining the flange is divided into at least one center section between the tube ends and an end section located away from the flange, and that these sections have different wall thicknesses and/or different inner diameters and/or outer diameters from each other. In this way, the respective installation conditions can be taken into account.

Corresponding to the method step of severing one or more curved wall sections addressed above, according to an optional embodiment of the invention, portions advantageously protruding radially from the tube of shaft end are configured to form the flange, the portions being disposed at different distances from each other in or parallel to the circumferential tube direction. So as to increase stability, the projecting portions are connected via preferably round flange stub sections, which are bent at the shaft end to form radially projecting terminal edges. The flange stub sections preferably have the shape of partial circular arcs between the protruding portions.

### DESCRIPTION OF THE VIEWS OF THE DRAWINGS

Further details, features, feature combinations and effects based on the invention will be apparent from the following description of preferred exemplary embodiments of the invention and from the drawings. In the drawings:

FIG. 1 shows a cross-sectional view of a hollow drive shaft according to the invention;

FIG. 2 shows a cross-sectional view of a pre-tube or starting tube for the production method according to the invention;

FIG. 3 shows the pre-tube according to FIG. 2 during the production step “integrally forming the driver edge;”

FIG. 4 shows the afore-mentioned pre-tube during the production step “preliminary ironing of the tube regions I and II;”

FIG. 5 shows the afore-mentioned pre-tube during the production step “intermediate annealing;”

FIG. 6 shows the afore-mentioned pre-tube during the production step “reducing the diameter on the driver edge;”

FIG. 7 shows the afore-mentioned pre-tube during the production step “ironing tube region I;”

FIG. 8 shows the afore-mentioned pre-tube during the production step “ironing tube region II;”

FIG. 9 shows the afore-mentioned pre-tube during the production step “ironing tube region III;”

FIG. 10 shows the afore-mentioned pre-tube during the production step “working the ends;”

FIG. 11 is a cut-off illustration of the end section of the afore-mentioned pre-tube which is associated with the flange formation during the production step “prestamping the flange region;”

FIG. 12 is a cross-sectional illustration according to line XII-XII in FIG. 11;

FIG. 13 shows the end section of the pre-tube which is associated with the flange formation during the production step “preforming the flange;”

FIG. 14 shows the end section of the pre-tube which is associated with the flange formation during the production step “flat forming and embossing the flange;”

FIG. 15 shows the end section of the pre-tube, or of the hollow drive shaft, which is associated with the flange region during the production step “cutting and piercing the flange;”

FIG. 16 shows an end view in the axial direction of the end face of the hollow drive shaft which is provided with the flange;

FIG. 17 shows a cross-sectional view of an alternative exemplary embodiment to FIG. 1 of the hollow drive shaft; and

FIG. 18 shows a perspective illustration of a further, alternative exemplary embodiment comprising a reinforcement rib in the tube/flange transition region.

### DETAILED DESCRIPTION OF THE INVENTION

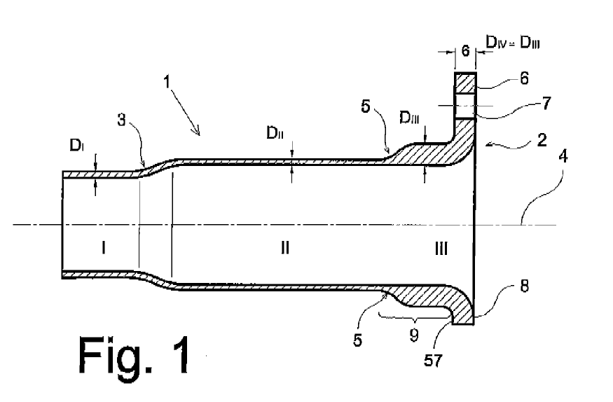

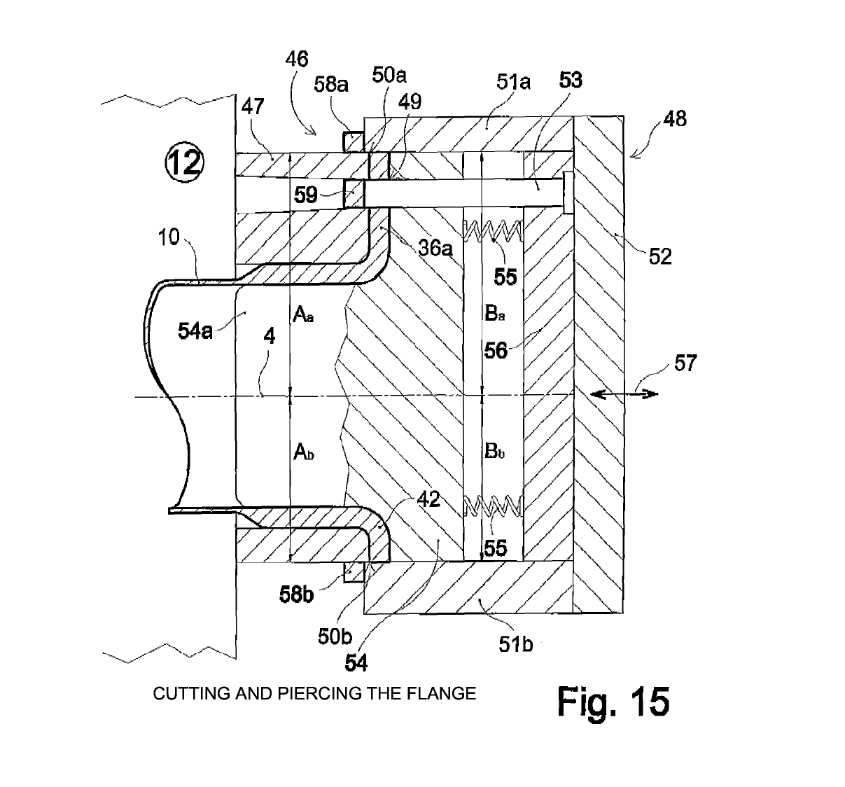

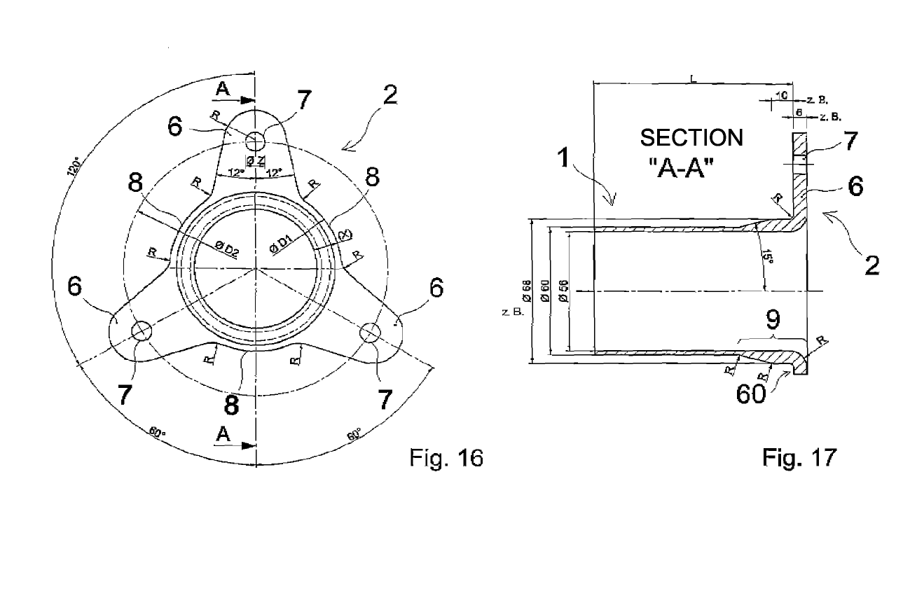

According to FIG. 1, the hollow drive shaft or the cardan shaft 1 is divided into a first longitudinal section I, a second longitudinal section II, and a third longitudinal section III. These can be distinguished from each other by geometric dimensions. For example, the first longitudinal section I, which is disposed at a distance or away from the finished flange 2 disposed in the third longitudinal section II, has the smallest inner and outer diameters and the wall thickness D_{I}. By way of a transition diameter expansion 3 having an obliquely increasing progressing with respect to the tube center axis 4 toward the flange end, this section transitions into the second longitudinal section II (“center section”) between the first longitudinal section I and the third longitudinal section III (“end sections”). The longitudinal section or center section II has the wall thickness D_{II} and a larger inner diameter and outer diameter than the first longitudinal or end section I. The center section II transitions by way of a second transition diameter expansion 5, which likewise increases obliquely with respect to the center axis 4 toward the flange end, into the third longitudinal section or second end section III. This section has approximately the same inner diameter as the neighboring center section II, however it has a larger outer diameter and also a considerably thicker wall thickness D_{III} than the center section II. The wall thickness D_{III} also continues in the individual finished flange protrusions 6 having screw holes 7 (see also FIGS. 15 and 16 with description) and in the circular arc-shaped finished flange stub sections 8.

According to FIG. 1, the cardan shaft 1 represents a so-called integral component, which is to say the finished flange 2 is produced in one piece, in one part or integrally with tube sections I to III by way of the cold forming technique described hereafter. A weld seam, for example for joining the flange to the tube end, is therefore not required. Due to the different outer diameters, which can be precisely implemented by the forming process described hereafter, it is possible to satisfy installation-related boundary conditions. The wall thicknesses D_{I}, D_{II}, D_{III} are adapted to the respective specific loads. For example, wall thickness D_{III} of the flange end region III was left considerably thicker compared to the remaining wall thicknesses D_{I}, D_{II}, whereby the finished flange 2 can absorb as high a torque as possible when coupled in the drive train. One example for the wall thickness dimensioning is as follows: D_{I}=1.8 mm; D_{II}=1.5 mm; D_{III}=D_{IV}=approx. 6 mm.

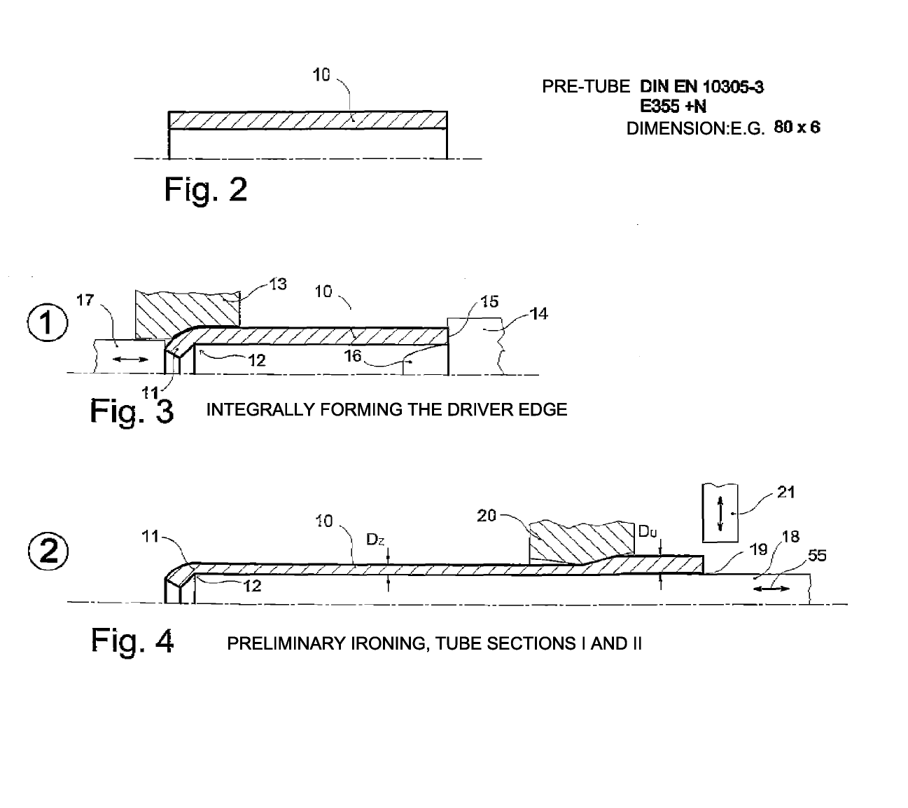

According to FIG. 1, flange end section III comprises the actual finished flange 2 (having the wall thickness D_{IV} and comprising the finished flange protrusions 6 and finished flange stub sections 8) and a transition section 9 that extends toward the center section II and has the wall thickness D_{III}. The flange transition section 9 advantageously has the same wall thickness as the remaining finished flange 2 or the parts 6, 8 thereof (D_{III}=D_{IV}). By designing the wall thicknesses of the first longitudinal sections I, II (outside flange end section III) relatively thin in relation to the longitudinal tube extension, a cardan shaft having a lightweight design is achieved. Compared to the pre-tube 10 (see FIG. 2), which represents the starting point for the production method according to the invention, the cardan shaft 1 has been extended approximately three to four fold, which is attributable to the multiple ironing operations as part of the cold forming technique that is employed (see description below). This also results in strain hardening and increased strength, in particular with respect to drive forces and torque.

The cylindrical pre-tube 10 indicated in FIG. 2 as the starting point of the method according to the invention can be a commercially available, longitudinally welded precision steel tube of the steel grade E355+N (see the standards EN 10305-2 or EN 10305-3 mentioned at the outset). The number 355 denotes the yield strength (355 N/mm²), and +N denotes that the tube was normalized after welding so as to recrystallize the coarse grain components that developed during welding in the crystal structure and create a homogeneous crystal structure across the entire cross-section. Other steel grades may also be used within the scope of the invention. Dimensions suitable for the cardan shaft production method according to the invention are, for example: longitudinal section=80 mm, wall thickness=6 mm, diameter 60 mm, for example. While the precision steel tubes according to the cited standard are unalloyed steels, alloyed steels can also be used within the scope of the invention, provided these have suitable yield strengths.

According to FIG. 3, in a first production step, driver means, for example in the form of a driver edge 11, are formed at one tube end located away from the (later) flange region, so that in the later production method a stop for further handling, such as by way of a mandrel, is available. The same can essentially dig itself into the groove 12 formed by the driver edge 11 and the adjoining tube inner wall and push the pre-tube in the longitudinal direction thereof into a forming tool (see below). The driver edge 11 is formed by way of a forming die 13 having a cavity that is complementary to the outer curvature of the driver edge 11. A ram 14 cooperates with the forming die 13 and is pressed against a tube end face 15 associated with the finished flange 2 (to be formed later) by way of actuating elements, which are not shown. A centering pin 16, which projects from the ram 14 and partially protrudes into the tube interior, is used to hold and center the pre-tube 10. After the end of the method step “integrally forming the driver edge,” the ram is detached from the tube end face 15 again, and the pre-tube 10 is released together with the driver edge 11 to move away from the forming die 13. An ejector 17 then presses against the end face of the driver edge 11, thereby pushing the pre-tube 10 out of the forming die 13.

The method step according to FIG. 4 involves considerably reducing the original tube wall thickness Dᵤ for the first longitudinal or end section I and the second longitudinal or center section II of the hollow drive shaft 1 to be produced. In addition, the outer and inner diameters of the pre-tube 10 are to be reduced at least to some degree. For this purpose, a first mandrel 18 having a uniform diameter is pushed into the pre-tube 10 to the stop on the inner groove 12 of the drive edge 11, wherein initially there is still a clearance 19 between the tube inner wall and the outer jacket of the mandrel 18, which allows the mandrel 18 to be pushed into the tube interior. Thereafter a first ironing ring 20 is pulled, starting from the driver edge 11, over the outer jacket of the pre-tube up to approximately the end of the region corresponding to the end of center section II. The steel material of the pre-tube 10 is thus pressed onto the outer jacket of the first mandrel 18, so that the pre-tube 10 surrounds the first mandrel 18 with preload in the preliminary ironing sections I, II. This preload is attributable to material cooling, among other things, which occurs after a certain heating of the material due to the mechanical energy input that occurred as a result of cold forming. Due to the volume constancy that applies between the pre-tube 10 and the end product, this being the hollow drive shaft 1, a tube extension is achieved corresponding to the wall thickness reduction that was carried out in the preliminary ironing step, from the original wall thickness Dᵤ to the intermediate wall thickness D_{z}. So as to complete the preliminary ironing operation, stripper means 21 are positioned as a stop for the tube end face associated with the (later) finished flange 2, and the mandrel is pulled out, overcoming the frictional engagement between the tube inner wall and the mandrel outer jacket. A stripping force of approximately 20 tons may occur between the tube end face and the stop surface of the stripping means 21.

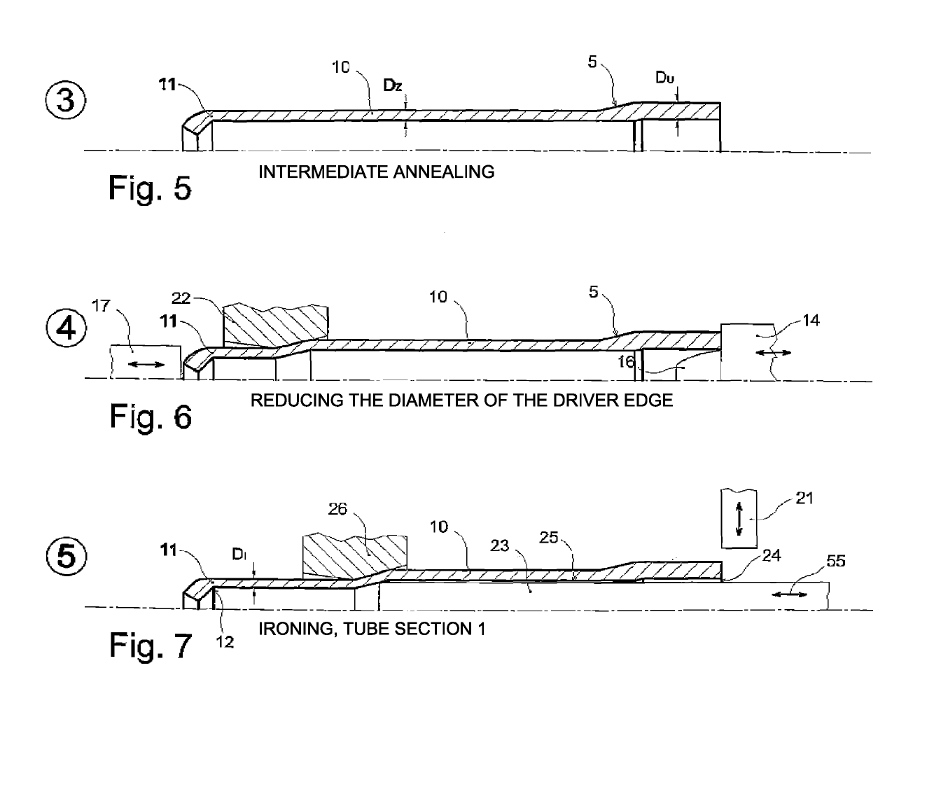

FIG. 5 shows the configuration of the intermediate tube product as it results after the preliminary ironing step. So as to compensate for the strain hardening occurring during this reduction of the wall thickness in the cold state, intermediate annealing (recrystallization annealing) is carried out as a further production step so as to restore the original structure, or as-delivered state, in the tube material. This allows or facilitates subsequent, further cold forming steps.

According to FIG. 6, the respective diameter of the driver edge 11 and of the adjoining region is reduced. For this purpose, the pre-tube 10 is pushed into a second, annular forming die 22 by way of the ram 14 having a plunging centering pin 16 (“pusher mandrel”) and is pushed through this die, which includes the forming elements (complementary cavity, reduced inner diameter) necessary for diminishing the dimension of the pre-tube 10 in the region of the driver edge 11. The device and tool arrangement is similar to that of the first method step “integrally forming the driver edge” according to FIG. 3. However, the method step according to FIG. 6 does not result in any edge bending, but in a reduction of the inner and outer diameters of the driver edge 11 and of the region immediately adjoining the same (“reducing the dimension of the tube”). When this method step is completed, the pre-tube 10 is pushed out of the second forming die 22 by way of axial pressure using the ejector 17, analogously to the method step according to FIG. 3, after prior removal of the ram 14.

According to FIG. 7, the ironing of the first longitudinal or end section I of the pre-tube 10 is carried out. For this purpose, initially a second, two-stage mandrel 23, having the smaller outer diameter thereof at the front, is introduced into the pre-tube 10 up to the stop at the driver edge 11, wherein clearance 24, 25 still exists between the outer jacket of the second mandrel 23 and the inner wall of the pre-tube 10 prior to starting the ironing operation. The clearance between the tube inner wall and the mandrel outer jacket is eliminated in the tube region associated with the first longitudinal or end section I (see FIG. 1) by way of a second ironing ring 26, analogously to the preliminary ironing step according to FIG. 4. This is carried out up to the first transition diameter expansion 3. This results in the predetermined target wall thickness D_{I} for the first end section I, which can be 1.8 millimeters, for example (see FIG. 1).

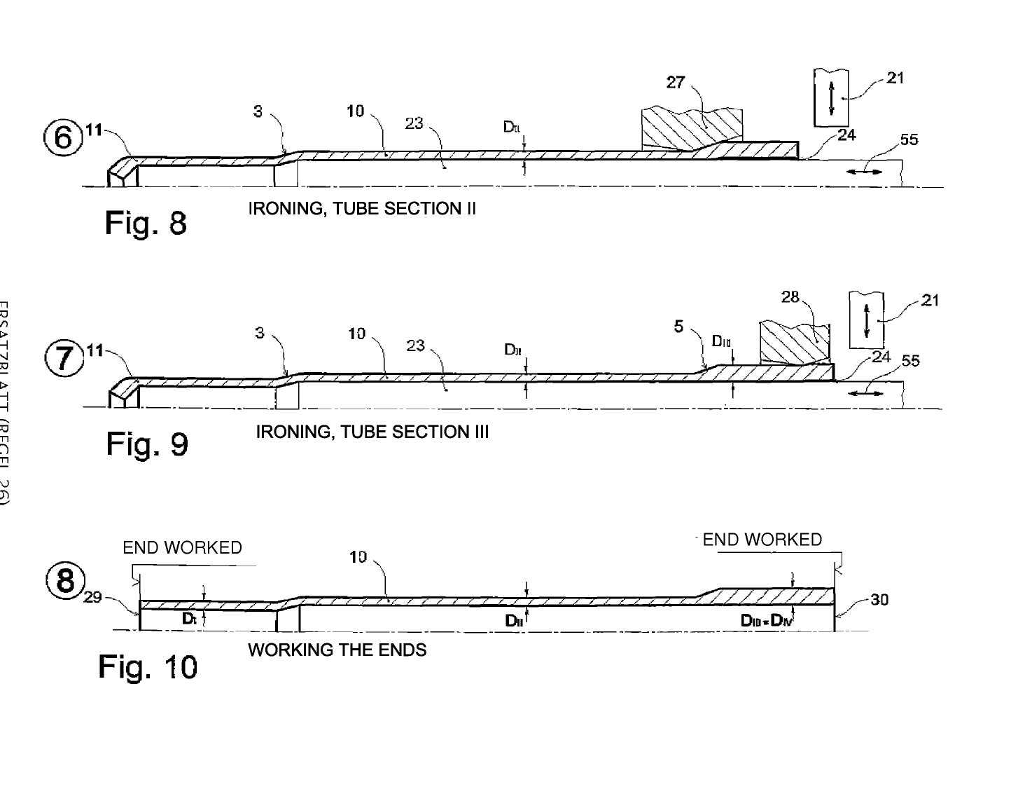

The second, two-stage mandrel 23 is left in the pre-tube 10 for the ironing operation of the tube center section II according to FIG. 8. Using a further, third ironing ring 27 having a larger inner diameter, the clearance 25 (see FIG. 7) that previously existed between the tube inner wall and the mandrel outer jacket is eliminated by way of cold forming (analogously to the preceding ironing steps). This is carried out up to the second transition diameter expansion 5.

According to FIG. 9, the two-stage mandrel 23 is again left in the tube interior for the ironing operation of the third tube longitudinal section III (end section associated with the flange). However, a further, fourth ironing ring 28 is used, the inner diameter of which is adapted to the tube outer diameter of the tube region adjoining the (later) finished flange 2 and to the wall thicknesses D_{III} of the flange transition section 9 and D_{IV} of the actual finished flange 2. Compared to the previous ironing steps, this last ironing operation causes the least degree of forming and is ultimately only intended to ensure precise, uniform wall thicknesses D_{III}, D_{IV} in the flange region so as to maximize the mechanical stability there.

According to FIG. 10, the two tube ends 29, 30 are worked after the ironing steps have been completed. This can be metal cutting by way of a lathe or the like, for example, wherein the driver edge 11 still shown in FIG. 9 is removed. The goal of the finishing operation is, among other things, to debur the terminal edges and achieve a planar design of the tube end faces.

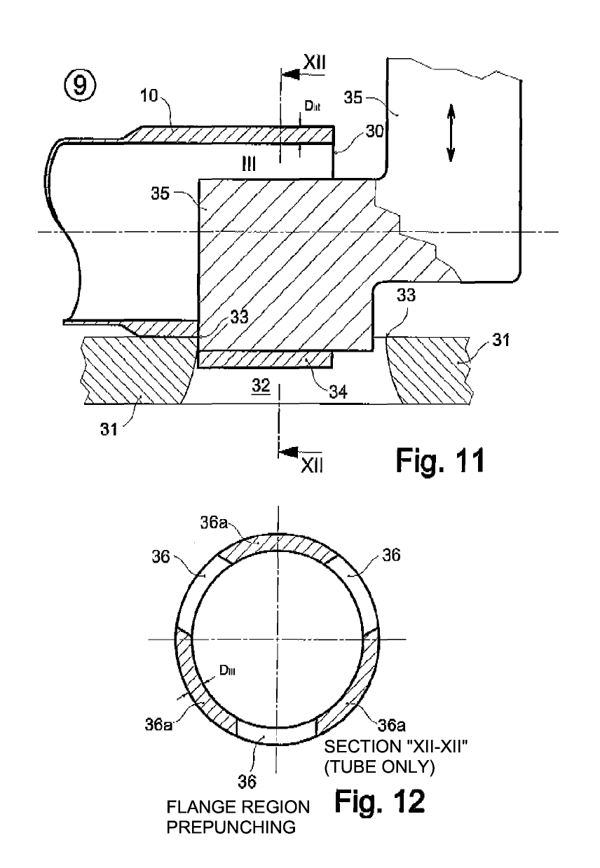

According to FIGS. 11 and 12, moreover a preliminary punching operation is carried out at the tube end 30 associated with the finished flange 2. The fixed pre-tube 10 is seated against a cutting die 31, which has a window-like cutting passage 32. This passage is delimited by sharp cutting edges 33. So as to punch a wall scrap part 34 out of the flange end section III of the pre-tube 10, a cranked cutting punch 35 moves along a first, for example linear, direction of movement toward the tube end 30 and then into the tube end along a direction of movement perpendicular thereto. With a further movement in the radial direction, which triggers the punching operation, the wall scrap part 34 is severed from the remaining tube wall by the sharp cutting edges 33, so that it can drop through the cutting passage 32.

According to FIG. 12, this punching operation is carried out three times consecutively or simultaneously. This could be implemented either by way of a rotation of the pre-tube or by way of a triple punch (not shown). To simultaneously punch out three wall parts, the triple punch would be actuated so as to extend three cutting punches 35, which are located offset from each other by 120° with respect to the tube circumferential direction. In this way, three wall scrap parts 34 could be punched out across the tube circumference in a single operation, for example offset in each case by 120° from each other, but simultaneously. The cross-section of the resulting tube end, having three tube gaps 36 distributed uniformly across the tube circumference between the pre-punched unworked flange protrusions 36a, is shown in FIG. 12. The end-face, axially parallel tube gaps 36 are provided to reduce material resistance so as to avoid excessive stress, in particular of the outer fibers of the material, during the subsequent formation of the flange by way of cold bending.

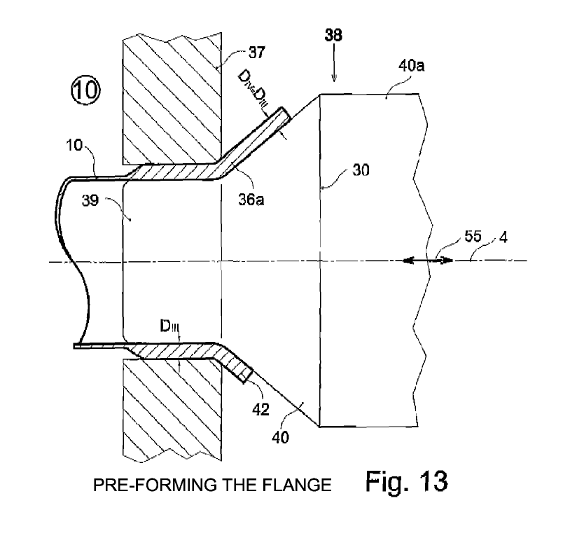

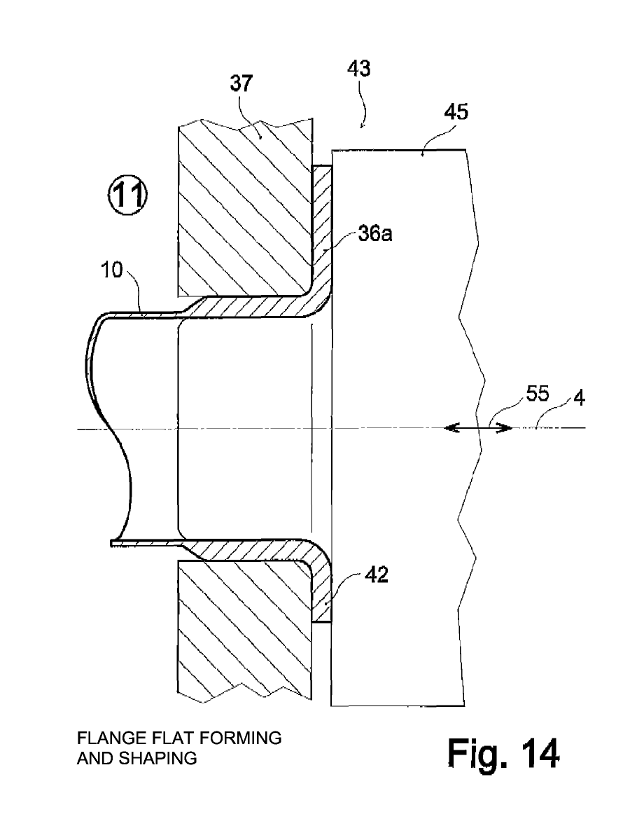

According to FIGS. 13 and 14, the process of forming the flange can be divided into a pre-forming step (FIG. 13) and a flat forming step (FIG. 14).

According to FIG. 13, in the pre-forming step the pre-tube 10 is surrounded by an annular holding die 37 in the flange region or within the flange end section III. The circular cylindrical centering end 39 of a sectionally conical bending punch 38 is introduced into the interior of the tube end 30. The tube end 30 is bent into an angled position with respect to the center tube axis 4 by way of the conically expanding or tapering cone section 40, which connects the centering end 39 to a circular cylindrical punch shaft 40a (shown broken off) of the bending punch 38. The tube wall end regions seated against the bending punch cone section 40 are moved into the described oblique position with respect to the center axis 4 as part of the insertion of the bending punch 38 into the tube end 30 under axial pressure. This applies not only to the unworked flange pieces 36a protruding at a distance from each other, which delimit the tube gaps 36 and later form the finished flange protrusions 6 (see FIGS. 1 and 16), but also to the unworked flange stub sections 42, which are disposed in between at the end face and connect the unworked flange protrusions 36a and which represent the respective delimitations of the tube gaps 36 at the back. The cone section 40 of the bending punch 38 advantageously has an angled course of approximately 45° with respect to the center axis 4.

According to FIG. 14, the production step “flat forming and embossing the flange” follows. For this step, a bending and embossing punch 43 having an approximately circular cylindrical centering end 44 protruding as an end face is used. Together with the directly adjoining, radial embossing expansion 45 (shown broken off), the outer wall of the punch forms an orthogonal design contour, by way of which the unworked flange piece 36a protruding at the end face from the tube or shaft end and the considerably shorter stub section 42 are bent into a radially or perpendicularly projecting position with respect to the center axis 4. At the same time, by way of the radial embossing expansion 45, the bending and embossing punch 43 applies a high pressure reaching the material yield strength onto the tube material seated against the die 37, which equates to an embossing step. A planar shape can be implemented at the flange end face by way of the embossing component combined with the flat forming step. The step of flat and planar pressing clearly defines the geometry of the flange end face. Optionally, for example, a radially extending corrugation can be integrally formed into the flange end face as part of the embossing step, which serves to stabilize and reinforce the flange, and more particularly to absorb torque. Advantageously the same die 37 can be used as a pressure pad for the operations “preforming the flange” (FIG. 13) and “flat forming and embossing the flange” (FIG. 14).

According to FIG. 15, the respective outer edges of the unworked flange protrusions 36a and of the unworked flange stub sections 42 are to be cut so as to form the finished flange 2. Moreover, the unworked flange protrusions 36a are to be provided with the screw holes 7 according to FIGS. 1, 16 and 17. For this purpose a cutting device 46 is used, which comprises one or more cutting and piercing dies 47 surrounding the pre-tube 10 and engaging the unworked flange 36a, 42, and one or more opposing punching devices 48, which can be axially displaced with respect to the tube center axis 4. The (respective) cutting and piercing die 47 is designed with a cutting window 49 delimited by sharp cutting edges, the outline of the window being consistent with the screw hole 7 to be punched out according to FIGS. 1, 16 and 7. Moreover, the outer corners of the cutting and piercing die 47 are designed as one or more first cutting edges 50a and one or more second cutting edges 50b. The distance between the first cutting edges 50a and the tube center axis 4 is the larger distance Aₐ, corresponding to the further projection of the unworked flange protrusion 36a, and the distance between the second cutting edges 50b and the tube center axis 4 is the smaller distance A_{b}, corresponding to the lesser projection of the unworked flange stub sections 42 in relation to the tube center axis 4. As a result, the cutting and piercing die(s) 47 and (as described hereafter) the punching device(s) 48, and the cutting device 46 as a whole, are designed in a structure that is asymmetrical with respect to an (imaginary) tube center axis 4. Analogously, the (respective) punching device 48 is equipped with one or more first cutting punches 51a and one or more second cutting punches 51b, which are provided on a shared back yoke 52, and preferably are rigidly fixed thereon, and are connected to each other via the same. The first cutting punch or punches 51a in each case are disposed at the larger distance Bₐ from the tube center axis 4 (consistent with the larger cutting edge distance or distances Aₐ), and the second cutting punch or punches 51b in each case are disposed at the smaller distance B_{b} (consistent with the smaller cutting edge distance Aₐ) from the tube center axis 4. Congruently with the cutting window 49, a piercing punch 53 projects from the back yoke 52, so that the punch can penetrate the cutting window 49 by cooperating with the cutting edges. Moreover, one or more hold-down devices 54 (shown in partially cut views) are provided in the cutting device 46, each hold-down device having end-face centering appendages 54a, which are elastically resiliently supported against the back yoke 52, or an inner strip 56 attached in parallel thereon, by way of one or more parallel spring elements 55.

The mode of operation of the cutting device 46 is as follows: The device can be caused to carry out an axial back and forth displacement movement 57. As the unworked flange 36a, 42 of the pre-tube 10 is approached, the end face of the same is seated against the (respective) hold-down device 54, wherein it is pressed against the unworked flange end face due to the spring elements 55 that are supported at the back. In a further displacement movement 57 of the back yoke 52 with the inner strip 56 toward the pre-tube 10, the cutting punches 51a, 51b strike against the outer edges of the unworked flange protrusions 36a and the unworked flange stub sections 42. In cooperation with the cutting edges 50a, 50b of the cutting and piercing die 47, edge scrap pieces 58a, 58b are severed from the respective outer edge of the unworked flange protrusions 36a and of the unworked flange stub sections 42. At the same time, one or more wall scrap pieces 59 are pierced out of the respective unworked flange protrusions 36a by way of the piercing die or dies 53, wherein the finished screw holes 7 are created.

The end view according to FIG. 16 shows the finished formed flange 2, which comprises, for example, three finished flange protrusions 6 distributed 120 degrees apart, for example, and centrally disposed screw holes 7. These are disposed at a distance corresponding to an angle of circumference of 120° in the tube circumferential direction. The flange protrusions 6 are connected to each other via the (finished cut) flange stub sections 8, which according to FIGS. 1 and 17 form a radial overhang 60 with respect to the adjoining outer jacket and stabilize the flange region.

According to FIG. 17, the cardan shaft or the hollow drive shaft 1 can also have only two different wall thicknesses, namely the thinner one on the tube section up to the flange region and the thicker one in the flange transition region 9 and in the flange 2 itself.

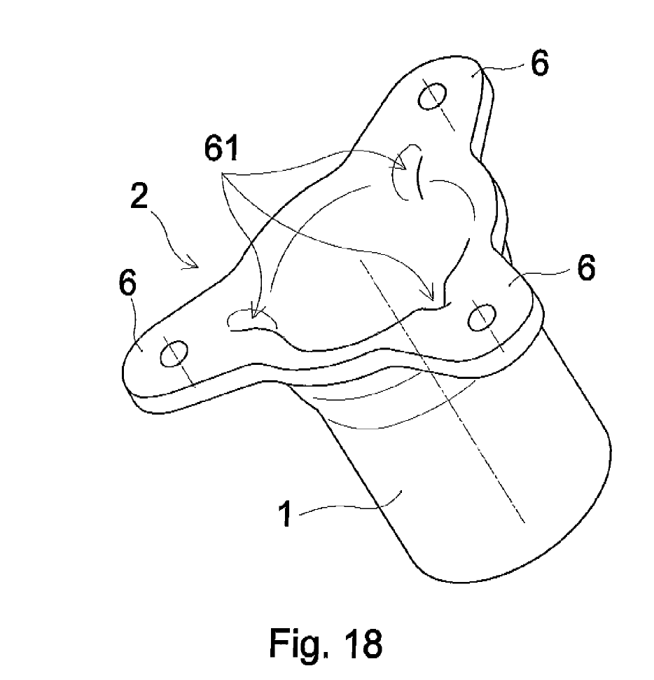

According to FIG. 18, a reinforcement rib 61 is associated with each of the three flange protrusions 6. In the specific exemplary embodiment, this reinforcement rib is implemented as a recess in the region of the inner wall where the tube shape transitions via a 90° bend into a flange protrusion 6. For forming the reinforcement rib 61, the recess in each case extends at an angle of approximately 90°.

### LIST OF REFERENCE NUMERALS

1 cardan shaft or hollow drive shaft
I first longitudinal section
II second longitudinal section, center section
III third longitudinal section, flange end section
D_{I}, D_{II} wall thicknesses
D_{III}, D_{IV} wall thicknesses
2 finished flange
3 transition diameter expansion
4 tube center axis
5 second transition diameter expansion
6 finished flange protrusion
7 screw hole
8 finished flange stub section
9 flange transition section
10 pre-tube
11 driver edge
12 groove
13 annular forming die
14 ram
15 end face
16 centering pin
17 ejector
Dᵤ original wall thickness
18 first mandrel
19 clearance
20 first ironing ring
D_{z} intermediate wall thickness
21 stripper
22 second annular forming die
23 second, two-stage mandrel
24, 25 clearance
26 second ironing ring
27 third ironing ring
28 fourth ironing ring
29, 30 tube ends
31 cutting die
32 cutting passage
33 cutting edge
34 wall scrap part
35 cutting punch
36 tube gap
36a unworked flange protrusion
37 holding die
38 conical bending punch
39 centering end
40 cone section
40a punch shaft
41 not assigned
42 unworked flange stub section
43 bending and embossing die
44 centering end of the same
45 radial embossing expansion
46 cutting device
47 cutting and piercing die
48 punching device
49 cutting window
50a first cutting edge
50b second cutting edge
Aₐ larger distance of first cutting edge
A_{b} smaller distance of second cutting edge
51ₐ first cutting punch
51_{b} second cutting punch
52 back yoke
Bₐ larger distance of first cutting punch
B_{b} smaller distance of second cutting punch
53 piercing punch
54 hold-down device
54a centering appendage
55 spring elements
56 inner strip
57 displacement movement
58ₐ edge scrap piece
58_{b} edge scrap piece
59 wall scrap piece
60 overhang
61 reinforcement rib

1. A method for producing a tubular, hollow drive shaft (1), which is a cardan shaft, from a pre-tube (10), which is a longitudinally welded, normalized steel tube, and which is extended by having the wall thickness thereof reduced at least sectionally by way of single or multiple ironing or another cold forming operation or by having the inner diameter or outer diameter thereof changed, characterized in that at least one pre-tube end (30) or shaft end is configured into a flange (2) that is integrated in one piece by way of cold forming.

2. The method according to claim 1, characterized in that a portion (I, II) of the pre-tube (10) not associated with the flange (2) or not adjoining the flange is ironed, or changed by way of cold forming, in such a way that a portion (III, 9) of the drive shaft (1) associated with the flange or adjoining the flange has the thickest wall (D).

3. The method according to claim 2, characterized in that the cold forming operation of the pre-tube or shaft end (30) to obtain the flange (2) includes single or multiple ironing operations of the end and subsequent bending of the end.

4. The method according to claim 3, in which as part of the formation of the flange, in a pre-forming step the wall at the end (30) of the pre-tube (10) is given an angled position with respect to a tube center axis (4) by way of an at least sectionally conical bending punch (38), and in a subsequent flat forming step the obliquely positioned wall that is in an angled position is given a perpendicular position with respect to the tube center axis by way of an orthogonal bending punch (43), characterized in that the bending punches (38, 43) are moved (55) exclusively in a rectilinear manner during the formation of the flange.

5. The method according to claim 4, in which as part of the formation of the flange, in a pre-forming step the wall at the end (30) of the pre-tube (10) is given an angled position with respect to the tube center axis (4) by way of an at least sectionally conical bending punch (38), and in a subsequent flat forming step the obliquely positioned wall that is in an angled position is given a perpendicular position with respect to the tube center axis by way of an orthogonal bending punch (43), characterized in that, during the flat forming step, an end face of the flange (2) is embossed by way of the orthogonal bending punch (43), forming a corrugation or a reinforcement rib (61).

6. A method according to claim 5, characterized in that one or more wall parts (34) are punched out or severed at an associated pre-tube or shaft end (30), prior to formation of the flange.

7. A method according to claim 6, characterized by a preliminary ironing operation of one or more tube sections (I, II), which in each case are disposed at a distance from the tube end region (III, 9) associated with the flange (2), wherein a reduction of the respective wall thickness (D) and/or a narrowing and/or expansion of the respective inner and/or outer diameters are carried out.

8. The method according to claim 7, characterized by an intermediate annealing step of the pre-tube (10) following the preliminary ironing operation.

9. A method according to claim 7, characterized by an ironing operation, or another cold forming operation, of an end section (I) of the pre-tube (10) not associated with the flange (2), wherein at least a reduction of the outer diameter and/or inner diameter of the pre-tube and/or of the wall thickness (D_{I}) of the pre-tube is carried out using a forming tool (26) specifically designed for this purpose.

10. A method according to claim 7, characterized by an ironing operation, or another cold forming operation, of at least one center section (II) of the pre-tube (10) not associated with the flange (2) and located between the tube ends (29, 30), wherein at least a reduction of the outer diameter and/or inner diameter of the pre-tube and/or of the wall thickness (D_{II}) thereof is carried out using a forming tool (27) specifically designed for this purpose.

11. A method according to according to claim 7, characterized by an ironing operation, or another cold forming operation, of a flange end section (III) of the pre-tube associated with the flange (2), wherein at least a reduction of the outer diameter and/or inner diameter of the pre-tube and/or of the wall thickness (D_{III}) of the pre-tube (10) is carried out using a forming tool (28) specifically designed for this purpose, and the outer diameter and/or inner diameter of the flange end section (III) and/or the wall thickness (D_{III}) thereof are reduced the least as compared to the other pre-tube section or sections (I, II).

12. A hollow drive shaft, in particular a cardan shaft, which is hardened by way of ironing and/or another cold forming operation and in this process is given differing wall thicknesses (D_{I},D_{II},D_{III}) or differing inner diameters and/or outer diameters across the longitudinal extension thereof, characterized by a strain-hardened flange that is formed integrally or in one piece with at least one end (30) by way of cold forming.

13. The drive shaft according to claim 12, characterized in that the flange (2) has a greater thickness (D_{III}) or a greater diameter than the remaining shaft or tube sections (I, II).

14. A drive shaft according to claim 13, characterized in that a shaft or tube portion not associated with the flange (2) and/or adjoining the flange (2) is broken down at least into a center section (II) and an end section (I) located away from the flange, and the aforementioned sections have differing wall thicknesses (D_{I},D_{II}) or differing inner diameters or outer diameters.

15. A drive shaft according to claim 14, characterized in that the flange (2) is formed by portions (6; 41) protruding over the tube or shaft end (30), the portions being disposed at distances from each other in or parallel to a tube circumferential direction.

16. The drive shaft according to claim 15, characterized in that the protruding portions (6; 41) are connected by way of circular arc-shaped flange tube sections (42), which project outwardly at an angle, at the shaft end (30).
